(19) United States
(12) Patent Application Publication
(10) Pub. No.: US 2026/0028870 A1
(43) Pub. Date: Jan. 29, 2026

(54) ELONGATED ELEMENT WITH EMBEDDED REINFORCEMENT

(71) Applicant: CERTAINTEED GYPSUM, INC., Malvern, PA (US)

(72) Inventors: Stephen P. Cline, Lancaster, PA (US); Eric L. Bewley, Bend, OR (US); Michael C. House, Bend, OR (US)

(21) Appl. No.: 19/273,246

(22) Filed: Jul. 18, 2025

Related U.S. Application Data
(60) Provisional application No. 63/674,817, filed on Jul. 24, 2024.

(51) Int. Cl. E06B 1/62; E04F 13/08

(52) U.S. Cl. CPC E06B 1/62; E04F 13/0805; E06B 2001/628

(57) ABSTRACT

An elongated element can include a first flange and a second flange, where the first flange is joined to the second flange at an apex, and a reinforcement element can be embedded within the elongated element, where the reinforcement element is made from a first material and the elongated element is made from a second material, wherein the first material is different than the second material. A method can include extruding a reinforcement element from a first material, feeding the reinforcement element to an extruder, extruding a body of an elongated element from a second material, where the body comprises a first flange, a second flange, and a first apex, where the first flange is joined to the second flange at the first apex, and where the first material is different than the second material, and embedding the reinforcement element into the body.

### CROSS-REFERENCE TO RELATED APPLICATION(S)

This application claims priority under 35 U.S.C. § 119 (c) to U.S. Provisional Patent Application No. 63/674,817, filed on Jul. 24, 2024, entitled “ELONGATED ELEMENT WITH EMBEDDED REINFORCEMENT,” by Stephen P. CLINE et al., which is assigned to the current assignee hereof and is incorporated herein by reference in its entirety.

### FIELD OF THE DISCLOSURE

The present invention relates, in general, to the field of construction. More particularly, present embodiments relate to trim used in finishing surfaces in building construction.

### BACKGROUND

Trim used for finishing surfaces where two construction panels meet (such as corners in drywall construction, seams between drywall sheets, interface points between other construction panels) to help cover gaps between the construction panels and aid in improved aesthetics of the finished surfaces. However, impacts to the trim elements, such as corner trim, can cause damage to the trim structure and can require repair to return the surfaces to a pre-damaged appearance. Therefore, improvements in trim elements are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

One general aspect includes an elongated element configured to engage with one or more construction panels. The elongated element also includes a body that may include a first flange, a second flange, and a first apex, where the first flange is joined to the second flange at the first apex; and a reinforcement element embedded within the body, where the reinforcement element may include a first material and the body is made from a second material, where the first material is different than the second material.

One general aspect includes a method for manufacturing an elongated element. The method also includes extruding, via a first extruder, a reinforcement element from a first material; feeding the reinforcement element to a second extruder; extruding, via the second extruder, a body of an elongated element from a second material, where the body may include a first flange, a second flange, and a first apex, where the first flange is joined to the second flange at the first apex, and where the first material is different than the second material; and embedding the reinforcement element into the body.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1A is a representative functional diagram of a system for extruding an elongated element for use in finishing operations for a building, in accordance with certain embodiments;

FIG. 1B is a representative partial cross-sectional top view of a construction wall that can utilize one or more elongated elements, in accordance with certain embodiments;

FIGS. 2A-7 are various representative cross-sectional views of an elongated element, in accordance with certain embodiments; and

FIG. 8 is a representative flow diagram of a method for manufacturing an elongated element with an embedded reinforcement element therein, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

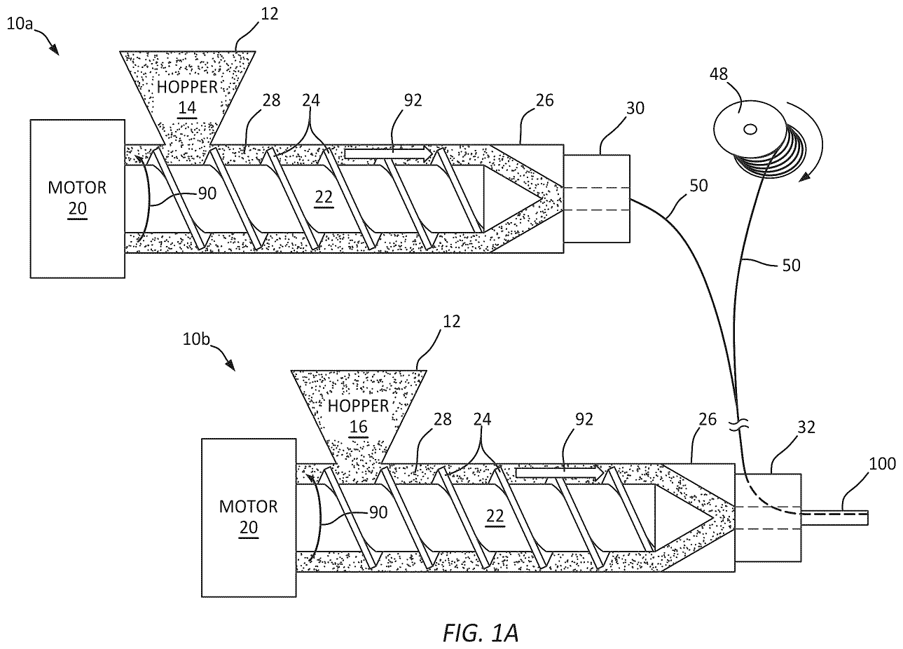

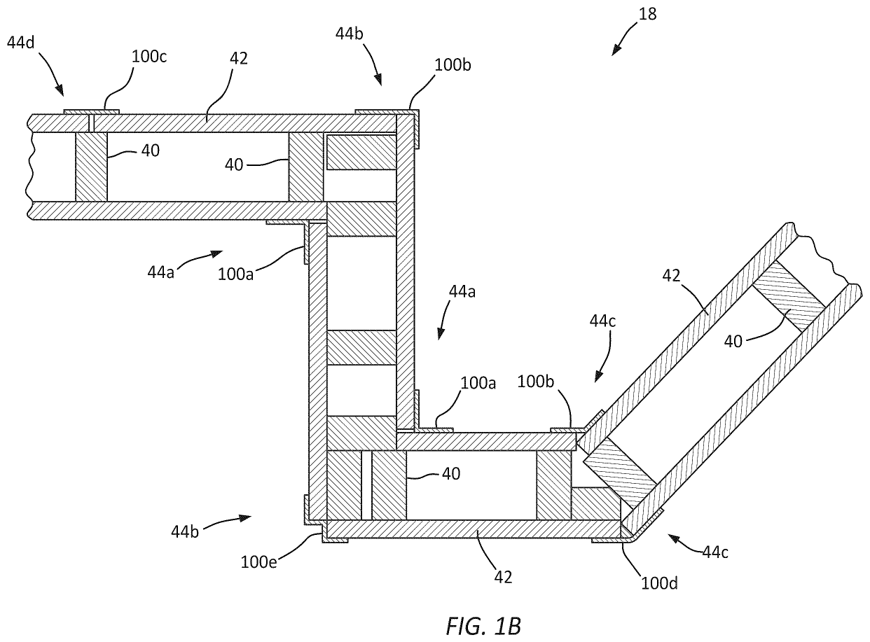

FIG. 1A is a representative functional diagram of a system for extruding an elongated element 100 which can be used in finishing operations for a building, in accordance with certain embodiments. It should be understood that the system shown in FIG. 1A is simplified for discussion purposes and is not intended to limit this disclosure or the claims. The extruders 10a, 10b can be any type of extrusion systems that receives extrudable material and forces the material through a die to form an elongated structure, such as the elongated element 100.

An extruder 10a can manufacture a reinforcement element 50 that can be used to reinforce an elongated element 100. An extrudable first material 14 can be supplied to a hopper 12 that can feed the first material 14 into an annulus 28 between a body 26 and a drive shaft 22 of the extruder 10a. As the drive shaft 22 is rotated (arrows 90) by a motor 20, helical fins 24 on the drive shaft 22 can move the first material 14 toward the die 30. As the first material 14 travels along the annulus 28 (arrows 92), heaters (not shown) can be used to heat up the first material 14 to its melting point in preparation for the first material 14 to be forced through the die 30.

The die 30 can be formed to produce a continuous or semi-continuous feed of one or more reinforcement elements 50 with a desired cross-sectional shape (e.g., a rectangle, a square, a circle, an oval, a triangle, an hourglass, a polygon, a star, a rectangular corner, an ellipsoid, etc.). The reinforcement element 50 can be continuously or semi-continuously extruded as long as the extruder 10a is not stopped and the first material 14 is supplied. The reinforcement element 50 can be stored on a reel 48 and then fed into a second extruder 10b or can be fed in real-time to the second extruder 10b to form the elongated element 100 with embedded one or more reinforcement elements 50.

The second extruder 10b can manufacture an elongated element 100 (e.g., corner trim, floor trim, corner trim, scam trim, edge trim, base board trim, door jamb trim, window trim, crown trim, gypsum corner bead trim, gypsum tape trim, gypsum finishing trim, etc.). The extrudable second material 16 can be supplied to a hopper 12 that can feed the second material 16 into an annulus 28 between a body 26 and a drive shaft 22. As the drive shaft 22 is rotated (arrows 90) by a motor 20, helical fins 24 on the drive shaft 22 can move the second material 16 toward the die 32. As the second material 16 travels along the annulus 28 (arrows 92), heaters (not shown) can be used to heat up the second material 16 to its melting point in preparation of the second material 16 being forced through the die 32. The die 32 is formed to produce a continuous feed of an elongated element 100 with a desired cross-sectional shape (e.g., V-shaped, L-shaped, U-shaped, Z-shaped, W-shaped, Step-shaped, flat-shaped, etc.).

The die 32 can be formed to receive the second material 16 from the annulus 28 of the extruder 10b as well as receive one or more reinforcement elements 50 from one or more extruders 10a, or from one or more reels 48, or from a combination thereof. The die 32 can be used to embed the one or more reinforcement elements 50 in a body 102 of the elongated element 100 as the elongated element 100 is being extruded through the die 32. It should be understood that one or more reinforcement elements 50 can also be embedded into the body 102 of the elongated element 100 after the body 102 has been extruded through the die 32. A laminate material (e.g., paper; paperboard; fiberglass, either oriented such as mesh, or non-oriented; textiles/fabrics either organic, non-organic, or blend; polymer films such as nylon, polyethylene terephthalate PET, polyether ether ketone PEEK, polyethylene PE; fabric; plastic; fiber mat; etc.) can be used for one or more of the laminates 104, 106 shown in the figures.

The laminate 104 can be adhered to one side of the body 102 of the elongated element 100 and the laminate 106 can be adhered to an opposite side of the body 102 of the elongated element 100 as the body 102 of the elongated element 100 is being extruded, as it is being cooled, after the elongated element 100 has been cooled, or after the elongated element 100 is cut to desired lengths. The elongated element 100 can be continuously or semi-continuously extruded as long as the extruder 10b is not stopped and the second material 16 is supplied to the extruder 10b. It should be understood that one or both laminates can be omitted from the elongated element 100. Even though the laminate 104 is shown on only one side of the elongated element 100, the laminate 104 can be applied to either side of the elongated element 100, with the other side not covered by a laminate. Even though the laminate 106 is shown on only one side of the elongated element 100, the laminate 106 can be applied to either side of the elongated element 100, with the other side not covered by a laminate. It should be understood that the laminates 104 and 106 can be made from different materials but are not required to be.

The first material 14 comprises an extrudable material, such as tin, zinc, iron, copper, aluminum, steel, or alloys thereof, as well as thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

The second material 16 comprises an extrudable material, such as tin, zinc, iron, copper, aluminum, steel, or alloys thereof, as well as thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

Even though the first material 14 and the second material 16 can be made from the same material, it is preferred that the first material 14 provides greater stability or resiliency for the elongated element 100 when embedded into the second material 16 than when the second material 16 is used solely to form the elongated element 100. Therefore, the first material 14 can be denser than the second material 16, the first material can be stronger than the second material 16, or the first material 14 can have a higher tensile strength than the second material 16.

The elongated element 100 made from the second material with one or more reinforcement elements 50, 50′ embedded in the body 102 can have an impact damage that is at least 5% less than an impact damage of a second elongated element that is made from the second material without one or more reinforcement elements being embedded in a second body of the second elongated element, wherein the impact damage is measured per an ASTM standard C1921.

In some embodiments, the first material 14 can be a polymer such as polyethylene, and the second material 16 can be a polypropylene. In some embodiments, the first material 14 can be a polypropylene and the second material 16 can be a material with a higher tensile strength such as a polyamide or a nylon. In some embodiments, the first material 14 can be a polymer of any kind and the second material can be an extrusion of a metal, such as a tin, zinc, iron, copper or steel.

The reinforcement elements 50, 50′ can have a major diameter (in cross-section) that varies along at least a portion of the reinforcement elements 50, 50′. This varied major diameter can be beneficial in restricting (or preventing) longitudinal movement of the one or more reinforcement elements 50, 50′ relative to the body 102 of the elongated element 100. As used herein, the “major diameter” refers to the largest cross-sectional distance across the cross-section of the elongated element 100. For example, the largest cross-sectional distance across a circular cross-section is merely the diameter of the circle. For example, the largest cross-sectional distance across an oval cross-section is the distance from an outermost point of one major lobe to an outermost point of the other major lobe. For example, the largest cross-sectional distance across a star cross-section is the distance from an outermost point of a first spire of the star to an outermost point of a second spire of the star, where the first spire is spaced away from the second spire by at least another spire of the star. For example, the largest cross-sectional distance across a rectangle cross-section is the length of a long side of the rectangle.

It should be understood that the elongated element 100 can also be formed through other processes, such as injection molding, press molding, etc. The elongated elements 100 can have reinforcement elements 50, 50′ embedded in the body 102 by pressing the reinforcement elements 50, 50′ into the body, the reinforcement elements 50, 50′ can be glued to the elongated elements 100 to provide improved strength, and or the reinforcement elements 50, 50′ can be embedded in the elongated elements 100 by heating the elongated elements 100 enough to allow the reinforcement elements 50, 50′ to be embedded into the body 102. The reinforcement elements 50, 50′ may also be laid into a mold area, and the elongated elements 100 formed by the encapsulation of the reinforcements through the hardening of the material after the molding process.

FIG. 1B is a representative partial cross-sectional top view of a wall 18 that can utilize one or more elongated elements 100 in finishing operations for the wall 18, in accordance with certain embodiments. In a non-limiting embodiment, construction panels 42 (e.g., gypsum board, plywood, cement board, tile back board, metal panels, fiberglass panels, etc.) can be attached to a wall 18 (e.g., a wall of studs 40, concrete wall, etc.) adjacent to each other, where it can be desirable to cover a space in the wall 18 where two adjacent construction panels 42 meet. The two adjacent construction panels can meet at an inside corner (e.g., corner 44a), an outside corner (e.g., corner 44b), an angled corner other than 90 degrees (e.g., corner 44c), or a lateral portion (e.g., corner 44d) of the wall where the two adjacent construction panels 42 are generally parallel with each other and in line with each other along the wall with a gap therebetween, as illustrated in the examples shown in FIG. 1B. In addition, a single construction panel 42 can be fabricated to include one or more corners and the elongated element 100 can be used to provide additional damage protection for the one or more corners.

Other possible locations for using the elongated element 100 can be along base boards, along where a wall 18 meets a ceiling, along where the wall meets a door jamb or window trim, along where the construction panels meet each other along the wall (such as reveal trim), or adhered to a construction panel away from the edges of the construction panel. The elongated element 100 can be used to span a gap formed between the two adjacent construction panels 42 and to be adhered to the ends of two adjacent construction panels on either side of the gap to support finishing operations.

As can be seen, a V-shaped elongated element 100a (i.e., both flanges of the elongated element 100 are substantially equal in length) can be used to span a gap between the two adjacent construction panels 42 in an inside corner (or an outside corner or an angled corner). As will be explained in more detail below, the V-shaped elongated element 100a can be used to span the gap between two adjacent construction panels 42 that are angled other than 90 degrees relative to each other.

As can be seen, an L-shaped elongated element 100b (i.e., both flanges of the elongated element 100 are substantially not equal in length) can be used to span a gap between the two adjacent construction panels 42 in an outside corner (or an inside corner or an angled corner). As will be explained in more detail below, the L-shaped elongated element 100b can be used to span the gap between two adjacent construction panels 42 that are angled other than 90 degrees relative to each other.

As can be seen, a flexible apex V-shaped elongated element 100c (i.e., both flanges of the elongated element 100 are substantially equal in length) can be used to span a gap between the two adjacent construction panels 42 at a lateral portion of the wall 18. As will be explained in more detail below, the flexible apex V-shaped elongated element 100c can be used to span the gap between two adjacent construction panels 42 that are angled from 45 degrees to 180 degrees relative to each other.

As can be seen, a U-shaped elongated element 100d (i.e., both flanges of the elongated element 100 are substantially equal in length with a curved apex therebetween) can be used to span a gap between the two adjacent construction panels 42 in an outside corner (or an angled corner). As will be explained in more detail below, the U-shaped elongated element 100d can be used to span the gap between two adjacent construction panels 42 that are angled other than 90 degrees relative to each other.

As can be seen, a W-shaped elongated element 100e (i.e., both flanges of the elongated element 100 are substantially equal in length with a V-shaped step therebetween) can be used to span a gap between the two adjacent construction panels 42 in an outside corner (or an angled corner). As will be explained in more detail below, the W-shaped elongated element 100e can be used to span the gap between two adjacent construction panels 42 that are angled other than 90 degrees relative to each other.

As should be understood, many more shapes that support finishing operations for a building are envisioned by the inventors. Any of these other shapes can be reinforced by embedding one or more reinforcement elements in the body of the elongated element 100.

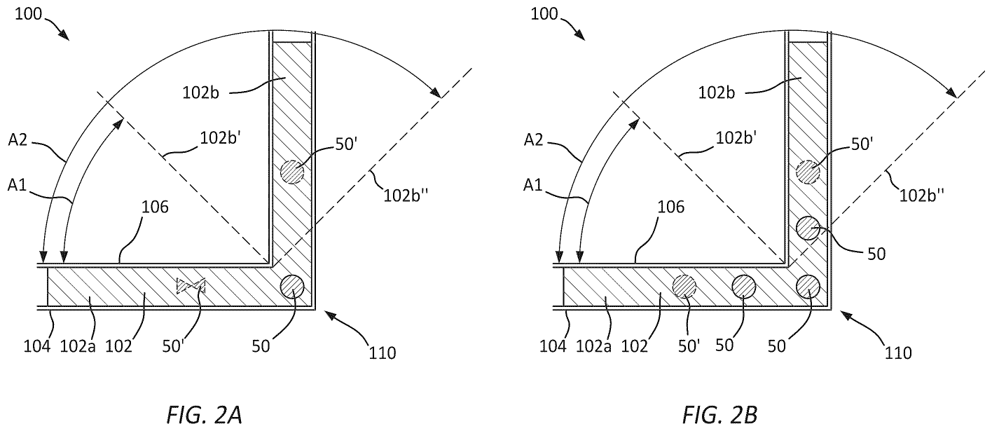

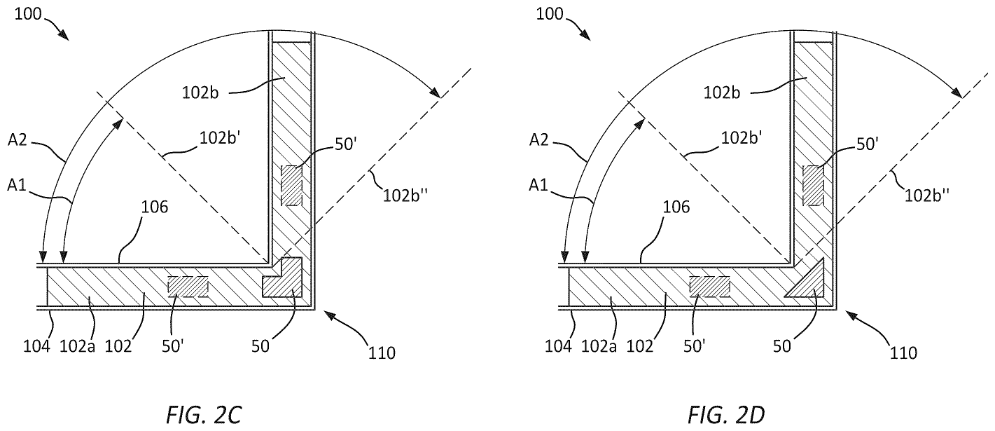

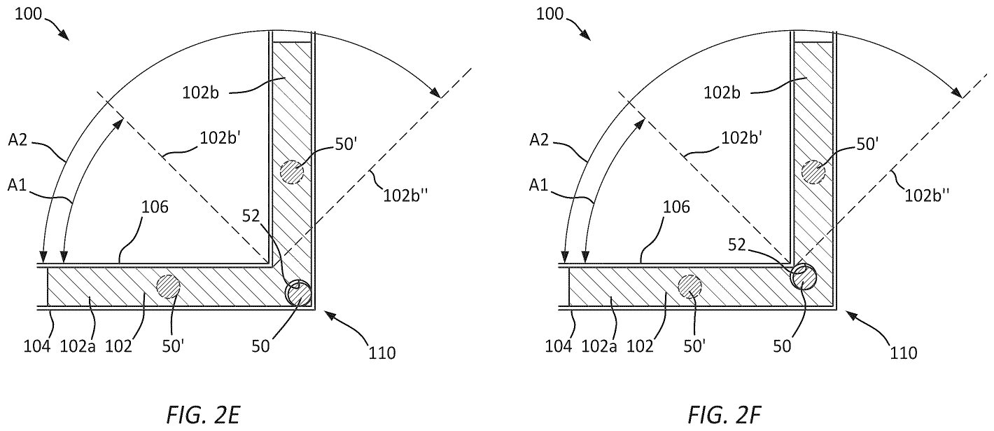

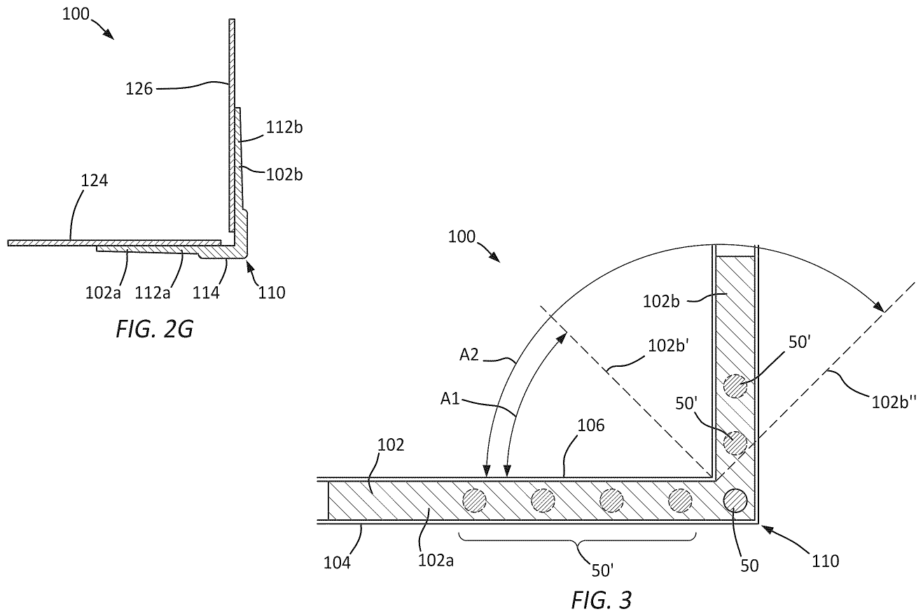

FIGS. 2A-7 are various representative cross-sectional views of certain embodiments of an elongated element 100. It should be understood that these specific embodiments of the elongated element 100 are provided as non-limiting examples to clarify the inventive concepts. However, other extruded elongated elements can also benefit from the aspects of this disclosure, such as cable-routing covers, case panels, etc.

FIGS. 2A-2F are representative cross-sectional views of a V-shaped elongated element 100, in accordance with certain embodiments. The elongated element 100 can include one or more reinforcement elements 50, 50′ embedded in the body 102. The body 102 can include an apex 110 and two flanges (or body portions) 102a, 102b that can be angled relative to each other from the angle A1 to the angle A2, where angle A1 can be 45 degrees and angle A2 can be 135 degrees. As shown, the body portion 102b can be angled relative to the body portion 102a from the position 102b′ to the position 102b″. The V-shaped elongated element 100 can be referred to as a fixed V-shape that can still be flexed at the apex 110 from angle A1 to angle A2.

Preferred locations of the reinforcement elements are shown as reinforcement elements 50 with solid lines, and optional locations being shown as reinforcement elements 50′ with dashed lines. However, even the locations shown as reinforcement elements 50 with solid lines can be optional locations for reinforcement elements. This is also true for the other elongated elements 100 shown in FIGS. 3-7.

It should also be understood that one or more of the reinforcement elements 50, 50′ can be made from a different material than the other ones of the reinforcement elements 50, 50′. Therefore, one or more materials of the first material 14 can be used to make the reinforcement elements 50, 50′, where at least one of the reinforcement elements 50, 50′ can be made from a different material than the other ones of the reinforcement elements 50, 50′. One or more of the reinforcement elements 50, 50′ in an elongated element 100 can be made from different material than other ones of the reinforcement elements 50, 50′ in the elongated element 100. This is also true for the other elongated elements 100 shown in FIGS. 3-7.

Additionally, other locations for the reinforcement elements 50, 50′ other than the ones shown for any of the certain embodiments in FIGS. 2A-7 are also possible. It should be understood that the relative location of any of the reinforcement elements 50, 50′ within the body 102 can vary along the elongated element 100.

Referring to FIG. 2A, various cross-sectional shapes for the reinforcement elements 50, 50′ are shown, with one of the reinforcement elements 50′ being hourglass shaped and the other reinforcement element 50′ and the reinforcement element 50 being circular. However, it should be understood that any of the cross-sectional shapes (e.g., a rectangle, a square, a circle, an oval, a triangle, an hourglass, a diamond, a polygon, a pentagon, a hexagon, a star, a rectangular corner, an ellipsoid, a trapezoid, etc.) can be used for any of the locations of the reinforcement elements 50, 50′.

It should also be understood that the FIGS. 2A-2F and FIGS. 3-7 are simplified cross-sectional views of the embodiment of the elongated elements 100. These figures represent the rudimentary shapes of the elongated elements 100, but it should be understood that the cross-sectional shape can be more complex while keeping with the principles of the disclosure. For example, the V-shaped elongated element 100 shown in FIGS. 2A-2F can have a more complex structure than illustrated by these figures, such as in FIG. 2G. FIG. 2G illustrates a V-shaped elongated element 100 that can have reduced thickness portions 112a, 112b at the flanges 102a, 102b (or body portions 102a, 102b), respectively, with an enlarged thickness body portion 114 at the apex 110.

These more complex structures can be used to aid in finishing out the surfaces of the wall 18, such as by allowing a joint compound to be floated over the reduced thickness portions 112a, 112b up to the enlarged thickness body portion 114 to provide a crisp transition between the adjacent construction panels 42 at the corner. Similar or more complex structures can be included as needed in the various elongated elements 100 provided in this disclosure. Even though more complex structures are not shown for the other embodiments of the elongated element 100, it should be understood that these and other complex structures are envisioned for the various embodiments.

Additionally, as shown in FIG. 2G, the elongated element 100 can include flaps 124, 126 adhered to inside surfaces as an alternative to, or in addition to, the laminate 106. It should also be noted that the flaps 124, 126 can be adhered to outside surfaces as an alternative to, or in addition to, the laminate 104. Flaps 124, 126 can be made from various materials such as paper, paperboard, fiberglass, fabric, plastic, fiber mat, or combinations thereof. It should be understood that the laminates 104, 106 can perform the function of the flaps 124, 126. The flaps 124, 126 (or laminates 104, 106) can act as a substrate to improve adhesion of the elongated element 100 to the construction panel 42 surfaces, or adhesion of materials to be applied to the elongated element 100. While the flaps 124, 126 are shown extending beyond the flanges 102a, 102b of the elongated element 100, they can serve the same purpose even when laminated and terminating at the edge of the flanges 102a, 102b.

Referring to FIG. 2B, various other locations are shown for the circular reinforcement elements 50, 50′. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

Referring to FIG. 2C, various locations are shown for rectangular reinforcement elements 50′ and a rectangle corner-shaped reinforcement element 50 that can be embedded into the body 102 of the elongated element 100. It should be understood that more or fewer reinforcement elements 50, 50′ can be embedded in the elongated element 100. Even though only rectangular reinforcement elements 50, 50′ are shown, it should be understood that any of these reinforcement elements 50, 50′ can be any of the cross-sectional shapes mentioned above.

Referring to FIG. 2D, various locations are shown for rectangular reinforcement elements 50′ and a triangular reinforcement element 50 that can be embedded into the body 102 of the elongated element 100. It should be understood that more or fewer reinforcement elements 50, 50′ can be embedded in the elongated element 100. Even though only rectangular and triangular reinforcement elements 50, 50′ are shown, it should be understood that any of these reinforcement elements 50, 50′ can be any of the cross-sectional shapes mentioned above.

Referring to FIG. 2E, various locations are shown for circular reinforcement elements 50, 50′ that can be embedded into the body 102 of the elongated element 100. In this non-limiting embodiment, at least one of the reinforcement elements 50, 50′ are installed in a longitudinal channel 52 that is formed to receive a reinforcement element 50, 50′. This illustrates that the reinforcement element 50, 50′ does not have to be completely enclosed in the body 102 of the elongated element 100. The body material (i.e., second material 16) can be used to adhere the reinforcement element 50, 50′ to the longitudinal channel 52 or an adhesive can be used to retain the reinforcement element 50, 50′ in the longitudinal channel 52. The reinforcement element 50, 50′ can be embedded along an outside surface, or in this case along the outside corner at the apex 110. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

Referring to FIG. 2F, various locations are shown for circular reinforcement elements 50, 50′ that can be embedded into the body 102 of the elongated element 100. In this non-limiting embodiment, at least one of the reinforcement elements 50, 50′ are installed in a longitudinal channel 52 that is formed to receive a reinforcement element 50, 50′. As in FIG. 2E, this illustrates that the reinforcement element 50, 50′ does not have to be completely enclosed in the body 102 of the elongated element 100. The body material (i.e., second material 16) can be used to adhere the reinforcement element 50, 50′ to the longitudinal channel 52 or an adhesive can be used to retain the reinforcement element 50, 50′ in the longitudinal channel 52. The reinforcement element 50, 50′ can be embedded along an outside surface, or in this case along the inside corner at the apex 110. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

FIG. 3 is a representative cross-sectional view of an L-shaped elongated element 100, in accordance with certain embodiments. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include an apex 110 and two flanges (or body portions) 102a, 102b that can be angled relative to each other from the angle A1 to the angle A2, where angle A1 can be 45 degrees and angle A2 can be 135 degrees. As shown, the body portion 102b can be angled relative to the body portion 102a from the position 102b′ to the position 102b″. The L-shaped elongated element 100 can be referred to as a fixed L-shape that can still be flexed at the apex 110 from angle A1 to angle A2. In the L-shaped configuration, either flange 102a, 102b can be longer than the other flange 102a, 102b.

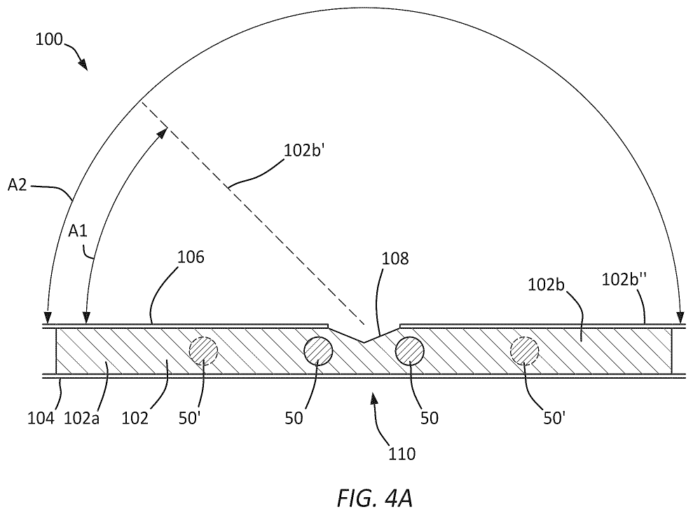

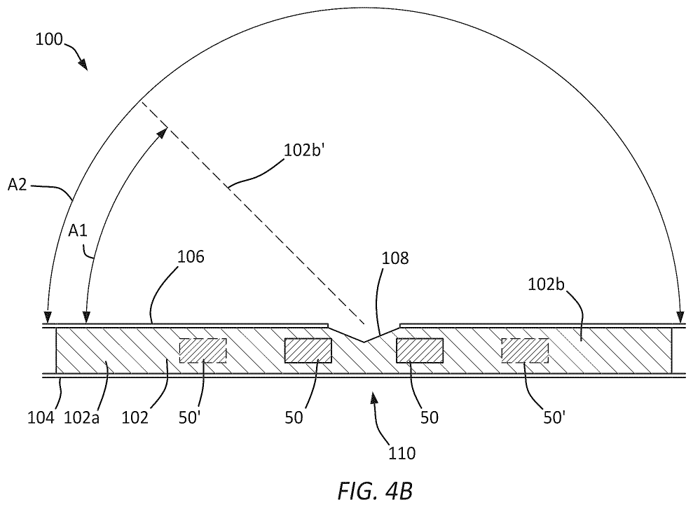

FIG. 4A is a representative cross-sectional view of a flexible apex 110 V-shaped elongated element 100, in accordance with certain embodiments. A relief 108 can be formed in an inside surface of the elongated element 100 to enable a larger flex angle than in versions without the relief 108. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include an apex 110 and two flanges (or body portions) 102a, 102b that can be angled relative to each other from the angle A1 to the angle A2, for example—where angle A1 can be 45 degrees and angle A2 can be 180 degrees. As shown, the body portion 102b can be angled relative to the body portion 102a from the position 102b′ to the position 102b″. The V-shaped elongated element 100 can be referred to as a flexible apex 110 V-shaped elongated element 100 that can be flexed at the apex 110 from angle A1 to angle A2. For example, the angle A1 can also be as low as 1 degree, such that the range of angles that the body portion 102b can be flexed at the apex 110 can be 1 degree through 180 degrees.

FIG. 4B is a representative cross-sectional view of a flexible apex 110 V-shaped elongated element 100, in accordance with certain embodiments. Various locations are shown for rectangular reinforcement elements 50, 50′ that can be embedded into the body 102 of the elongated element 100. It should be understood that more or fewer reinforcement elements 50, 50′ can be embedded in the elongated element 100. Even though only rectangular reinforcement elements 50, 50′ are shown, it should be understood that any of these reinforcement elements 50, 50′ can be any of the cross-sectional shapes mentioned above.

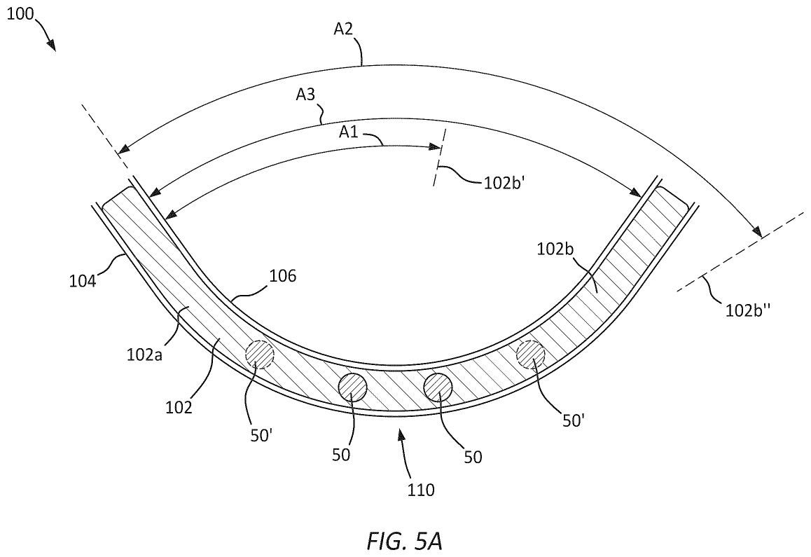

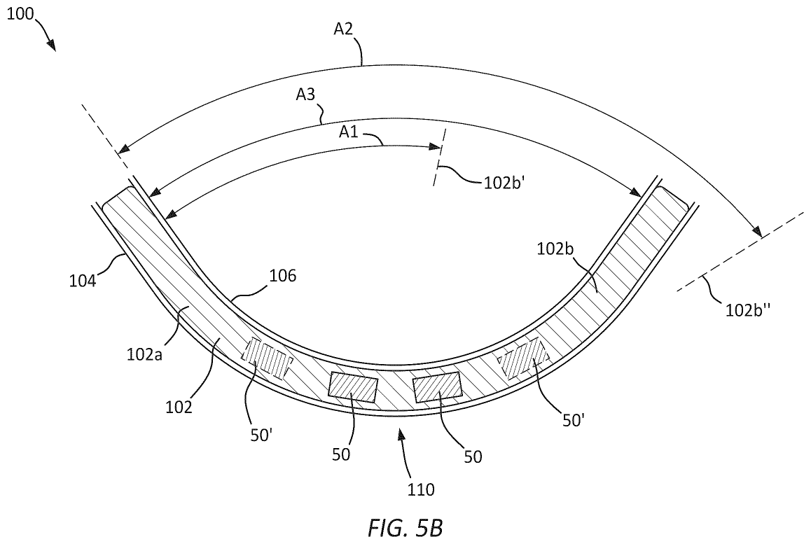

FIG. 5A is a representative cross-sectional view of a U-shaped elongated element 100, in accordance with certain embodiments. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include an apex 110 and two flanges (or body portions) 102a, 102b that can be rounded to form a curved body 102. The flanges (or body portions) 102a, 102b can be angled relative to each other from the angle A1 to the angle A2, where angle A1 can be 45 degrees and angle A2 can be 135 degrees with reference to the apex 110. As shown, the body portion 102b can be angled relative to the body portion 102a from the position 102b′ to the position 102b″.

FIG. 5B is a representative cross-sectional view of a U-shaped elongated element 100, in accordance with certain embodiments. Various locations are shown for rectangular reinforcement elements 50, 50′ that can be embedded into the body 102 of the elongated element 100. It should be understood that more or fewer reinforcement elements 50, 50′ can be embedded in the elongated element 100. Even though only rectangular reinforcement elements 50, 50′ are shown, it should be understood that any of these reinforcement elements 50, 50′ can be any of the cross-sectional shapes mentioned above.

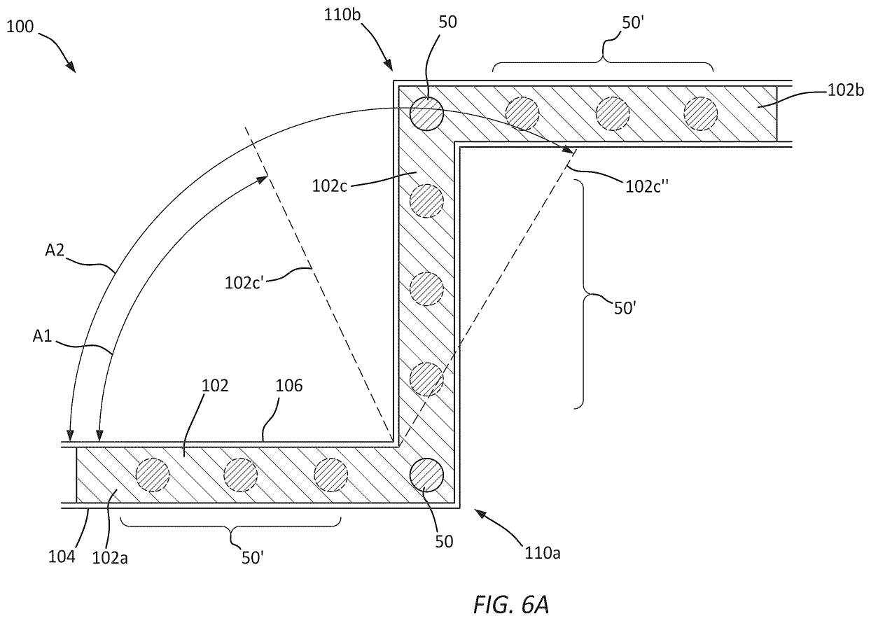

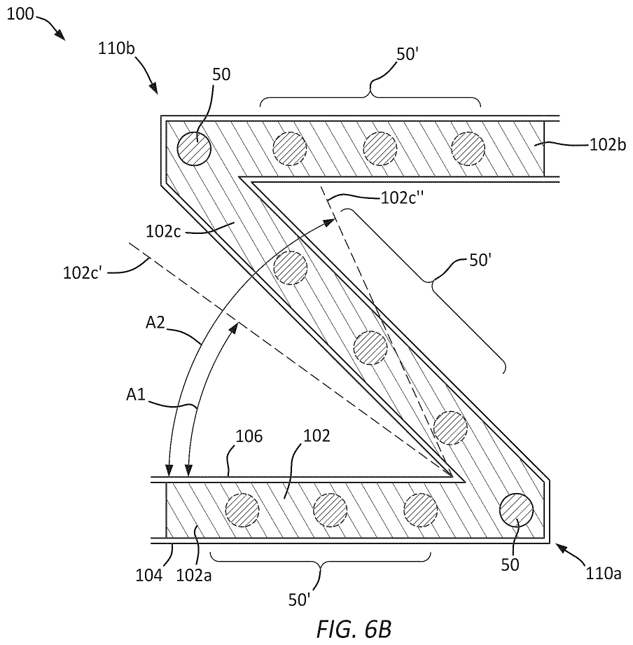

FIG. 6A is a representative cross-sectional view of a Z-shaped elongated element 100, in accordance with certain embodiments. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include apexes 110a, 110b, two flanges (or body portions) 102a, 102b, and a center body portion 102c. The flange 102a can be coupled to one end of the center portion 102c at the apex 110a and the flange 102b can be coupled to an opposite end of the center portion 102c at the apex 110b to form a Z-shape. The center body portion 102c can be angled relative to the flange (or body portion) 102a from the angle A1 to the angle A2, where angle A1 can be 60 degrees and angle A2 can be 120 degrees with reference to the apex 110a. Similarly, the center body portion 102c can be angled relative to the flange (or body portion) 102b from the angle A1 to the angle A2, where angle A1 can be 60 degrees and angle A2 can be 120 degrees with reference to the apex 110b. As shown, the body portion 102c can be angled relative to the body portion 102a from the position 102c′ to the position 102c″ with reference to the apex 110a. Similarly, the body portion 102c can be angled relative to the body portion 102b with reference to the apex 110b.

FIG. 6B is a representative cross-sectional view of a Z-shaped elongated element 100, in accordance with certain embodiments. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include apexes 110a, 110b, two flanges (or body portions) 102a, 102b, and a center body portion 102c. The flange 102a can be coupled to one end of the center portion 102c at the apex 110a and the flange 102b can be coupled to an opposite end of the center portion 102c at the apex 110b to form a Z-shape. The center body portion 102c can be angled relative to the flange (or body portion) 102a from the angle A1 to the angle A2, where angle A1 can be 30 degrees and angle A2 can be 60 degrees with reference to the apex 110a. Similarly, the center body portion 102c can be angled relative to the flange (or body portion) 102b from the angle A1 to the angle A2, where angle A1 can be 30 degrees and angle A2 can be 60 degrees with reference to the apex 110b. As shown, the body portion 102c can be angled relative to the body portion 102a from the position 102c′ to the position 102c″ with reference to the apex 110a. Similarly, the body portion 102c can be angled relative to the body portion 102b with reference to the apex 110b.

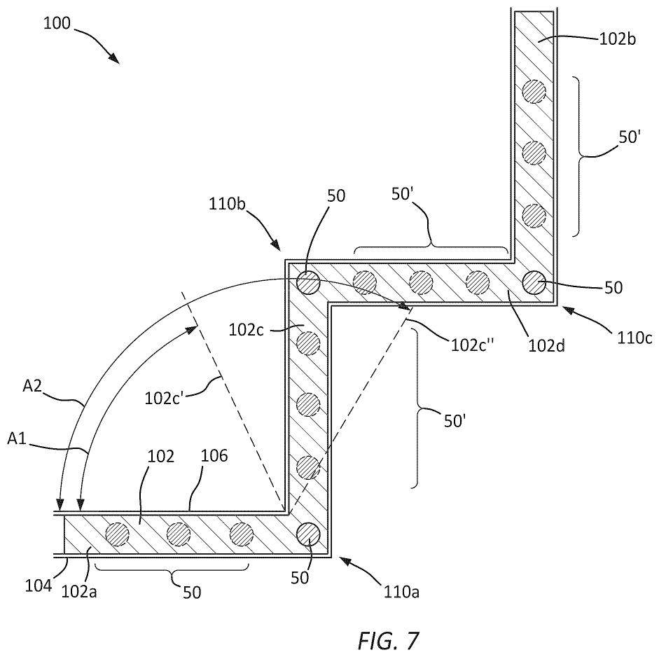

FIG. 7 is a representative cross-sectional view of a W-shaped elongated element 100, in accordance with certain embodiments. Various locations are shown for the circular reinforcement elements 50, 50′ that can be embedded into the body 102 of the elongated element 100. It should be understood that more or fewer reinforcement elements 50, 50′ can be embedded in the elongated element 100. Even though only circular reinforcement elements 50, 50′ are shown, it should be understood that any of these reinforcement elements 50, 50′ can be any of the cross-sectional shapes mentioned above.

The body 102 can include apexes 110a, 110b, 110c, two flanges (or body portions) 102a, 102b, and two center body portions 102c, 102d. The flange 102a can be coupled to one end of the center portion 102c at the apex 110a, a center portion 102d can be coupled to an opposite end of the center portion 102c at the apex 110b, and a flange 102b can be coupled to an opposite end of the center body portion 102d. The center body portion 102c can be angled relative to the flange (or body portion) 102a from the angle A1 to the angle A2, where angle A1 can be 60 degrees and angle A2 can be 120 degrees with reference to the apex 110a. Similarly, the center body portion 102d can be angled relative to the flange (or body portion) 102b from the angle A1 to the angle A2, where angle A1 can be 60 degrees and angle A2 can be 120 degrees with reference to the apex 110c.

Similarly, the center body portion 102c can be angled relative to the center body portion 102d from the angle A1 to the angle A2, where angle A1 can be 60 degrees and angle A2 can be 120 degrees with reference to the apex 110b. As shown, the center body portion 102c can be angled relative to the body portion 102a from the position 102c′ to the position 102c″ with reference to the apex 110a. Similarly, the center body portion 102d can be angled relative to the body portion 102b with reference to the apex 110c and the center body portion 102c can be angled relative to the center body portion 102d with reference to the apex 110b.

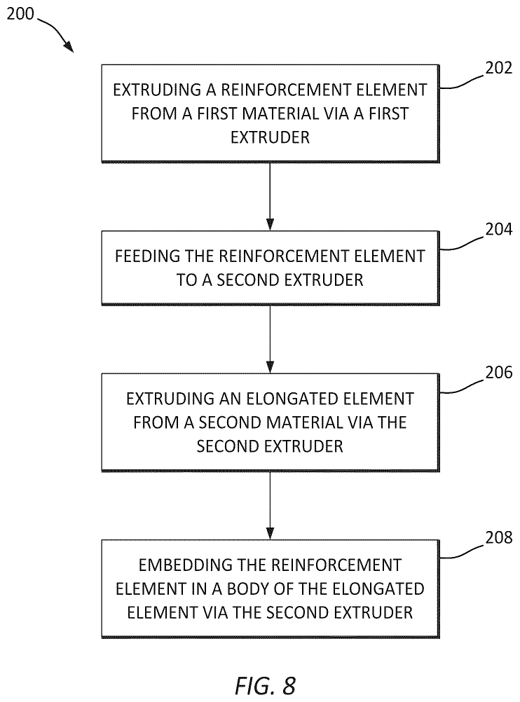

FIG. 8 is a representative flow diagram of a method 200 for manufacturing an elongated element 100 with an embedded reinforcement element 50, 50′ therein, in accordance with certain embodiments. In operation 202, a first material 14 can be fed into one or more extruders 10a and forced through a die 30 to produce one or more reinforcement elements 50. 50′. In operation 204, the one or more reinforcement elements 50, 50′ can be stored on one or more reels 48 and fed to a second extruder 10b from the one or more reels 48. The one or more reinforcement elements 50, 50′ can also be fed in real-time from the one or more extruders 10a to the extruder 10b.

In operation 206, a second material 16 can be fed into an extruder 10b and forced through a die 32 to produce an elongated element 100. In operation 208, the extruder 10b can direct the one or more reinforcement elements 50. 50′ into the die 32 to be embedded into the elongated element 100 as the elongated element 100 is being extruded through the die 32. Alternatively, or in addition to, the reinforcement elements 50. 50′ can be embedded in the body 102 of the elongated element 100 after the body 102 has been extruded through the die 32. The elongated element 100 can be cooled and cut into desired lengths before or after the reinforcement elements 50. 50′ are embedded into the body 102. If desired, one or more laminates 104, 106 can be applied to the elongated elements 100.

As used herein, the range of angles from 45 degrees to 135 degrees comprises angles greater than or equal to 45 degrees, greater than 50 degrees, greater than 55 degrees, greater than 60 degrees, greater than 65 degrees, greater than 70 degrees, greater than 75 degrees, greater than 80 degrees, greater than 85 degrees, or greater than 90 degrees, and angles less than or equal to 135, less than 130, less than 125, less than 120, less than 115, less than 110, less than 105, or less than 100. Therefore, the range of angles from 45 degrees to 135 degrees can comprise angles greater than or equal to 45 degrees and less than 130 degrees, greater than 60 degrees and less than or equal to 135 degrees, greater than 50 degrees and less than 100 degrees, etc.

As used herein, the range of angles from 45 degrees to 180 degrees comprises angles greater than or equal to 45 degrees, greater than 50 degrees, greater than 55 degrees, greater than 60 degrees, greater than 65 degrees, greater than 70 degrees, greater than 75 degrees, greater than 80 degrees, greater than 85 degrees, or greater than 90 degrees, and angles less than or equal to 180, less than 175, less than 170, less than 165, less than 160, less than 155, less than 150, less than 145, less than 140, less than 135, less than 130, less than 125, less than 120, less than 115, less than 110, less than 105, or less than 100. Therefore, the range of angles from 45 degrees to 180 degrees can comprise angles greater than or equal to 45 degrees and less than 175 degrees, greater than 60 degrees and less than or equal to 180 degrees, greater than 50 degrees and less than 125 degrees, etc.

As used herein, the range of angles from 30 degrees to 60 degrees comprises angles greater than or equal to 30 degrees, greater than 35 degrees, or greater than 40 degrees, and angles less than or equal to 60, less than 55, less than 50, or less than or equal to 45. Therefore, the range of angles from 30 degrees to 60 degrees can comprise angles greater than or equal to 30 degrees and less than 50 degrees, greater than 35 degrees and less than or equal to 60 degrees, greater than 40 degrees and less than 50 degrees, etc.

As used herein, the range of angles from 60 degrees to 120 degrees comprises angles greater than or equal to 60 degrees, greater than 65 degrees, greater than 70 degrees, greater than 75 degrees, greater than 80 degrees, greater than 85 degrees, or greater than or equal to 90 degrees, and angles less than or equal to 120, less than 115, less than 110, less than 105, or less than 100. Therefore, the range of angles from 60 degrees to 120 degrees can comprise angles greater than or equal to 60 degrees and less than 110 degrees, greater than 80 degrees and less than or equal to 120 degrees, greater than 70 degrees and less than 100 degrees, etc.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, “generally”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

### VARIOUS EMBODIMENTS

Embodiment 1. An elongated element configured to engage with one or more construction panels, the elongated element comprising:
a body that comprises a first flange, a second flange, and a first apex, wherein the first flange is joined to the second flange at the first apex; and
a reinforcement element embedded within the body, wherein the reinforcement element comprises a first material and the body is made from a second material, wherein the first material is different than the second material.

Embodiment 2. The elongated element of embodiment 1, wherein the one or more construction panels comprise one or more gypsum containing panels.

Embodiment 3. The elongated element of embodiment 1, wherein the first material is denser than the second material.

Embodiment 4. The elongated element of embodiment 1, wherein multiple reinforcement elements are embedded in the body.

Embodiment 5. The elongated element of embodiment 4, wherein the first material comprises a third material and a fourth material, wherein the multiple reinforcement elements comprise a first reinforcement element and a second reinforcement element, and wherein the first reinforcement element is made from the third material and the second reinforcement element is made from the fourth material, and wherein the third material is different than the fourth material.

Embodiment 6. The elongated element of embodiment 1, wherein the body is formed by extrusion, injection molding, or press molding.

Embodiment 7. The elongated element of embodiment 1, wherein the reinforcement element is formed by extrusion.

Embodiment 8. The elongated element of embodiment 1, wherein the body and the reinforcement element are extruded together.

Embodiment 9. The elongated element of embodiment 1, wherein the body is extruded and forms an extruded body, and the reinforcement element is embedded in the extruded body.

Embodiment 10. The elongated element of embodiment 1, wherein the reinforcement element is laid in a mold and the second material is formed around the reinforcement element to embed the reinforcement element in the body.

Embodiment 11. The elongated element of embodiment 1, wherein the body is extruded and forms an extruded body, and the reinforcement element is pressed into the extruded body.

Embodiment 12. The elongated element of embodiment 1, wherein a diameter of the reinforcement element varies along the reinforcement element.

Embodiment 13. The elongated element of embodiment 1, wherein the body and multiple reinforcement elements are extruded together.

Embodiment 14. The elongated element of embodiment 1, wherein the reinforcement element has a cross-section that is a rectangle, a square, a circle, an oval, a triangle, an hourglass, a diamond, a polygon, a pentagon, a hexagon, a star, a rectangular corner, an ellipsoid, or a trapezoid.

Embodiment 15. The elongated element of embodiment 1, wherein the body has a cross-section that is V-shaped, L-shaped, U-shaped, Z-shaped, W-shaped, Step-shaped, or flat-shaped.

Embodiment 16. The elongated element of embodiment 1, wherein the first flange is rotatable relative to the second flange within a range of angles from 1 degree to 180 degrees relative to the first apex.

Embodiment 17. The elongated element of embodiment 1, wherein the first apex is flexible, and wherein the first flange is rotatable relative to the second flange within a range of angles from 30 degrees to 180 degrees relative to the first apex.

Embodiment 18. The elongated element of embodiment 1, wherein the first apex is fixed, and wherein the first flange is rotatable relative to the second flange within a range of angles from 45 degrees to 135 degrees relative to the first apex.

Embodiment 19. The elongated element of embodiment 1, wherein the first material is stronger than the second material.

Embodiment 20. The elongated element of embodiment 1, wherein the first material is an extrudable material.

Embodiment 21. The elongated element of embodiment 20, wherein the extrudable material comprises one of tin, zinc, iron, copper, aluminum, steel, thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

Embodiment 22. The elongated element of embodiment 1, wherein the second material is an extrudable material.

Embodiment 23. The elongated element of embodiment 22, wherein the extrudable material comprises one of tin, zinc, iron, copper, aluminum, steel, thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

Embodiment 24. The elongated element of embodiment 1, wherein the reinforcement element is embedded in the body along any one of the first apex, the first flange, or the second flange.

Embodiment 25. The elongated element of embodiment 1, wherein the reinforcement element comprises one or more reinforcement elements, and wherein the reinforcement elements are embedded in any one of the first apex, the first flange, the second flange, or combinations thereof.

Embodiment 26. The elongated element of embodiment 1, wherein a first laminate is adhered to one side of the elongated element.

Embodiment 27. The elongated element of embodiment 26, wherein a second laminate is adhered to an opposite side of the elongated element.

Embodiment 28. The elongated element of embodiment 27, wherein the first laminate or the second laminate comprises paper; paperboard; fiberglass, either oriented such as mesh, or non-oriented; textiles/fabrics either organic, non-organic, or blend; polymer films such as nylon, polyethylene terephthalate PET, polyether ether ketone PEEK, polyethylene PE; fabric; plastic; fiber mat; or combinations thereof.

Embodiment 29. The elongated element of embodiment 26, wherein a first flap is adhered to an opposite side of the elongated element, and wherein the first flap is spaced away from the first apex and extends past an edge of the first flange.

Embodiment 30. The elongated element of embodiment 29, wherein a second flap is adhered to an opposite side of the elongated element, and wherein the second flap is spaced away from the first apex and the first flap, and extends past an edge of the second flange.

Embodiment 31. The elongated element of embodiment 30, wherein the first flap or the second flap comprises a paper, a paperboard, a fiberglass, a fabric, a plastic, a fiber mat, or combinations thereof.

Embodiment 32. The elongated element of embodiment 1, wherein the reinforcement element comprises a major diameter, and wherein the major diameter varies along at least a portion of a length of the reinforcement element.

Embodiment 33. The elongated element of embodiment 1, wherein an impact damage of the elongated element made from the second material is at least 5% less than an impact damage of a second elongated element that is made from the second material without one or more reinforcement elements being embedded in a second body of the second elongated element, wherein the impact damage is measured per an ASTM standard C1921.

Embodiment 34. The elongated element of embodiment 1, further comprising:
a third flange that is joined to the second flange at a second apex.

Embodiment 35. The elongated element of embodiment 34, wherein the first flange is rotatable relative to the second flange within a range of angles from 30 degrees to 60 degrees relative to the first apex, and the third flange is rotatable relative to the second flange within a range of angles from 30 degrees to 60 degrees relative to the second apex.

Embodiment 36. The elongated element of embodiment 34, wherein the first flange is rotatable relative to the second flange within a range of angles from 60 degrees to 120 degrees relative to the first apex, and the third flange is rotatable relative to the second flange within a range of angles from 60 degrees to 120 degrees relative to the second apex.

Embodiment 37. The elongated element of embodiment 34, wherein the reinforcement element comprises one or more reinforcement elements, and wherein the one or more reinforcement elements are embedded into one of the first flange, the second flange, the third flange, the first apex, the second apex, and a combination thereof.

Embodiment 38. The elongated element of embodiment 34, further comprising:
a fourth flange that is joined to the third flange at a third apex.

Embodiment 39. The elongated element of embodiment 38, wherein the first flange is rotatable relative to the second flange within a range of angles from 60 degrees to 120 degrees relative to the first apex, the third flange is rotatable relative to the second flange within a range of angles from 60 degrees to 120 degrees relative to the second apex, and the fourth flange is rotatable relative to the third flange within a range of angles from 60 degrees to 120 degrees relative to the third apex.

Embodiment 40. The elongated element of embodiment 38, wherein the reinforcement element comprises one or more reinforcement elements, and wherein the one or more reinforcement elements are embedded into one of the first flange, the second flange, the third flange, the fourth flange, the first apex, the second apex, the third apex, and a combination thereof.

Embodiment 41. A method for manufacturing an elongated element, the method comprising:
extruding, via a first extruder, a reinforcement element from a first material;
feeding the reinforcement element to a second extruder;
extruding, via the second extruder, a body of an elongated element from a second material, wherein the body comprises a first flange, a second flange, and a first apex, wherein the first flange is joined to the second flange at the first apex, and wherein the first material is different than the second material; and
embedding the reinforcement element into the body.

Embodiment 42. The method of embodiment 41, wherein embedding further comprises embedding the reinforcement element into the body while the body is being extruded.

Embodiment 43. The method of embodiment 41, wherein embedding further comprises embedding the reinforcement element into the body after the body has been extruded.

Embodiment 44. The method of embodiment 41, further comprising measuring an impact damage of the elongated element per an ASTM standard C1921.

Embodiment 45. The method of embodiment 44, wherein an impact damage of the elongated element made from the second material is at least 5% less than an impact damage of a second elongated element that is made from the second material without one or more reinforcement elements being embedded in a second body of the second elongated element, wherein the impact damage is measured per the ASTM standard C1921.

Embodiment 46. The method of embodiment 41, wherein extruding the reinforcement element further comprises extruding two or more reinforcement elements via one or more first extruders, and wherein embedding the reinforcement element further comprises embedding the two or more reinforcement elements in the body.

Embodiment 47. The method of embodiment 46, wherein the two or more reinforcement elements comprise a first reinforcement element and a second reinforcement element, wherein the first reinforcement element is made from the first material and the second reinforcement element is made from a third material, and wherein the first material is different than the third material.

Embodiment 48. The method of embodiment 47, wherein the first material and the third material are stronger than the second material.

Embodiment 49. The method of embodiment 41, further comprising varying a major diameter of the reinforcement element.

Embodiment 50. The method of embodiment 41, further comprising embedding the reinforcement element into the body along the first flange, the second flange, or the first apex as the body is being extruded.

Embodiment 51. The method of embodiment 41, wherein the body has a cross-section that is V-shaped, L-shaped, U-shaped, Z-shaped, W-shaped, Step-shaped, or flat-shaped.

Embodiment 52. The method of embodiment 41, wherein the reinforcement element has a cross-section that is a rectangle, a square, a circle, an oval, a triangle, an hourglass, a diamond, a polygon, a pentagon, a hexagon, a star, a rectangular corner, an ellipsoid, a trapezoid.

Embodiment 53. The method of embodiment 41, further comprising rotating the second flange relative to the first flange about the first apex to an angle that is within a range from 45 degrees to 180 degrees.

Embodiment 54. The method of embodiment 53, further comprising rotating the second flange relative to the first flange about the first apex to an angle that is within a range from 45 degrees to 135 degrees.

Embodiment 55. The method of embodiment 41, wherein the first material is stronger than the second material.

Embodiment 56. The method of embodiment 41, wherein the first material is an extrudable material.

Embodiment 57. The method of embodiment 56, wherein the extrudable material comprises one of tin, zinc, iron, copper, aluminum, steel, thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

Embodiment 58. The method of embodiment 41, wherein the second material is an extrudable material.

Embodiment 59. The method of embodiment 58, wherein the extrudable material comprises one of tin, zinc, iron, copper, aluminum, steel, thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

Embodiment 60. The method of embodiment 41, wherein the body further comprises a third flange that is joined to the second flange at a second apex.

Embodiment 61. The method of embodiment 60, further comprising:
rotating the first flange relative to the second flange about the first apex to a first angle that is within a range from 30 degrees to 60 degrees relative to the first apex; and
rotating the third flange relative to the second flange to a second angle that is within a range from 30 degrees to 60 degrees relative to the second apex.

Embodiment 62. The method of embodiment 60, further comprising:
rotating the first flange relative to the second flange about the first apex to a first angle that is within a range from 60 degrees to 120 degrees relative to the first apex; and
rotating the third flange relative to the second flange to a second angle that is within a range from 60 degrees to 120 degrees relative to the second apex.

Embodiment 63. The method of embodiment 60, wherein the reinforcement element comprises one or more reinforcement elements, and
further comprising embedding the one or more reinforcement elements into one of the first flange, the second flange, the third flange, the first apex, the second apex, and a combination thereof.

Embodiment 64. The method of embodiment 60, wherein the body further comprises a fourth flange that is joined to the third flange at a third apex.

Embodiment 65. The method of embodiment 64, further comprising:
rotating the first flange relative to the second flange about the first apex to a first angle that is within a range from 60 degrees to 120 degrees relative to the first apex;
rotating the third flange relative to the second flange to a second angle that is within a range from 60 degrees to 120 degrees relative to the second apex; and
rotating the fourth flange relative to the third flange to a third angle that is within a range from 60 degrees to 120 degrees relative to the third apex.

Embodiment 66. The method of embodiment 64, wherein the reinforcement element comprises one or more reinforcement elements, and further comprising embedding the one or more reinforcement elements into one of the first flange, the second flange, the third flange, the fourth flange, the first apex, the second apex, the third apex, and a combination thereof.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. An elongated element configured to engage with one or more construction panels, the elongated element comprising:
a body that comprises a first flange, a second flange, and a first apex, wherein the first flange is joined to the second flange at the first apex; and
a reinforcement element embedded within the body, wherein the reinforcement element comprises a first material and the body is made from a second material, wherein the first material is different than the second material.

2. The elongated element of claim 1, wherein multiple reinforcement elements are embedded in the body.

3. The elongated element of claim 1, further comprising at least one of:
wherein the body is formed by extrusion, injection molding, or press molding,
wherein the reinforcement element is formed by extrusion,
wherein the body and the reinforcement element are extruded together,
wherein the body is extruded and forms an extruded body, and the reinforcement element is embedded in the extruded body,
wherein the reinforcement element is laid in a mold and the second material is formed around the reinforcement element to embed the reinforcement element in the body,
wherein the body is extruded and forms an extruded body, and the reinforcement element is pressed into the extruded body,
wherein a diameter of the reinforcement element varies along the reinforcement element, and
wherein the body and multiple reinforcement elements are extruded together.

4. The elongated element of claim 1, wherein the reinforcement element has a cross-section that is a rectangle, a square, a circle, an oval, a triangle, an hourglass, a diamond, a polygon, a pentagon, a hexagon, a star, a rectangular corner, an ellipsoid, or a trapezoid, and wherein the body has a cross-section that is V-shaped, L-shaped, U-shaped, Z-shaped, W-shaped, Step-shaped, or flat-shaped.

5. The elongated element of claim 1, further comprising at least one of:
wherein the first flange is rotatable relative to the second flange within a range of angles from 1 degree to 180 degrees relative to the first apex,
wherein the first apex is flexible, and the first flange is rotatable relative to the second flange within a range of angles from 30 degrees to 180 degrees relative to the first apex,
wherein the first apex is fixed, and the first flange is rotatable relative to the second flange within a range of angles from 45 degrees to 135 degrees relative to the first apex,
wherein the first material has increased strength as compared to the second material, and
wherein the reinforcement element is embedded in the body along any one of the first apex, the first flange, or the second flange.

6. The elongated element of claim 1, wherein a first laminate is adhered to one side of the elongated element and a second laminate is adhered to an opposite side of the elongated element, and wherein the first laminate or the second laminate comprises paper; paperboard; fiberglass, either oriented such as mesh, or non-oriented; textiles/fabrics either organic, non-organic, or blend; polymer films such as nylon, polyethylene terephthalate PET, polyether ether ketone PEEK, polyethylene PE; fabric; plastic; fiber mat; or combinations thereof.

7. The elongated element of claim 6, wherein a first flap is adhered to an opposite side of the elongated element, and wherein the first flap is spaced away from the first apex and extends past an edge of the first flange, wherein a second flap is adhered to an opposite side of the elongated element, and wherein the second flap is spaced away from the first apex and the first flap, and extends past an edge of the second flange, and wherein the first flap or the second flap comprises a paper, a paperboard, a fiberglass, a fabric, a plastic, a fiber mat, or combinations thereof.

8. The elongated element of claim 1, wherein an impact damage of the elongated element made from the second material is at least 5% less than an impact damage of a second elongated element that is made from the second material without one or more reinforcement elements being embedded in a second body of the second elongated element, wherein the impact damage is measured per an ASTM standard C1921.

9. A method for manufacturing an elongated element, the method comprising:
extruding, via a first extruder, a reinforcement element from a first material;
feeding the reinforcement element to a second extruder;
extruding, via the second extruder, a body of an elongated element from a second material, wherein the body comprises a first flange, a second flange, and a first apex, wherein the first flange is joined to the second flange at the first apex, and wherein the first material is different than the second material; and
embedding the reinforcement element into the body.

10. The method of claim 9, wherein embedding further comprises embedding the reinforcement element into the body while the body is being extruded.

11. The method of claim 9, wherein embedding further comprises embedding the reinforcement element into the body after the body has been extruded.

12. The method of claim 9, wherein extruding the reinforcement element further comprises extruding two or more reinforcement elements via one or more first extruders, and wherein embedding the reinforcement element further comprises embedding the two or more reinforcement elements in the body.

13. The method of claim 12, wherein the two or more reinforcement elements comprise a first reinforcement element and a second reinforcement element, wherein the first reinforcement element is made from the first material and the second reinforcement element is made from a third material, and wherein the first material is different than the third material.

14. The method of claim 9, further comprising embedding the reinforcement element into the body along the first flange, the second flange, the first apex, or any combination thereof as the body is being extruded.

15. The method of claim 9, wherein the body has a cross-section that is V-shaped, L-shaped, U-shaped, Z-shaped, W-shaped, Step-shaped, or flat-shaped, and wherein the reinforcement element has a cross-section that is a rectangle, a square, a circle, an oval, a triangle, an hourglass, a diamond, a polygon, a pentagon, a hexagon, a star, a rectangular corner, an ellipsoid, or a trapezoid.

16. The method of claim 9, further comprising rotating the second flange relative to the first flange about the first apex to an angle that is within a range from 45 degrees to 180 degrees.

17. The method of claim 16, further comprising rotating the second flange relative to the first flange about the first apex to an angle that is within a range from 45 degrees to 135 degrees.

18. The method of claim 9, wherein the first material is an extrudable material, and wherein the extrudable material comprises one of tin, zinc, iron, copper, aluminum, steel, thermoplastic polymer, polyvinylchloride (PVC), chlorinated polyvinyl chloride (CVPC), polyethylene (PE), polypropylene (PP), nylon, polystyrene (PS), poly(acrylonitrile-butadiene-styrene) (ABS), poly (acrylic styrene acrylonitrile) (ASA), poly(acrylonitrile ethylene styrene) or poly(acrylonitrile ethylene propylene styrene) (AES), acrylic, polymethylmethacrylate, polycarbonate (PC), poly(methyl methacrylate) (PMMA), polyesters, polysulfones, polyphenylene oxide, PVC composite, PE composite, PP composite, or a combination thereof.

19. The method of claim 9, wherein the body further comprises a third flange that is joined to the second flange at a second apex.

20. The method of claim 19, wherein the reinforcement element comprises one or more reinforcement elements, and
further comprising embedding the one or more reinforcement elements into one of the first flange, the second flange, the third flange, the first apex, the second apex, and a combination thereof.
